(19) United States
(12) Patent Application Publication
(10) Pub. No.: US 2001/0008332 A1
(43) Pub. Date: Jul. 19, 2001

(54) Recreational vehicles

(76) Inventor: Jonathan Bisson, Ham Cottage (GB)

Correspondence Address: Lawrence M. Jarvis, McAndrews, Held & Malloy, Ltd., 34th Floor, 500 W. Madison Street, Chicago, IL, 60661, US

(21) Appl. No.: 09/760,393

(22) Filed: Jan. 12, 2001

(30) Foreign Application Priority Data
Jan. 14, 2000 (GB) 0000802.9
Feb. 22, 2000 (GB) 0004168.1

(51) Int. Cl. B62M 1/00

(52) U.S. Cl. 280/87.042; 280/87.041; 280/62

(57) ABSTRACT

A recreational vehicle is disclosed comprising front and rear sub-frames. Steerable wheels are mounted on the front sub-frame, and a rear wheel assembly on the rear sub-frame. The front wheels are steered by a mechanism operated by rotation of the rear sub-frame substantially about its longitudinal axis relative to the front sub-frame. The rotational axis of the wheel in the rear wheel assembly is fixed relative to the rear sub-frame such that when the rear sub-frame is rotated relative to the front sub-frame, the rear wheel leans correspondingly.

### BACKGROUND TO THE INVENTION

This invention relates to recreational vehicles, particularly to vehicles of the type upon which the user stands while it is in motion. Such vehicles are known, as “scooters”, “skateboards” and “mountain boards”, for example. The present invention is especially concerned with such vehicles having a pair of steerable front wheels, and a central rear wheel assembly.

Recreational vehicles of the kind to which the invention relates are disclosed in British Patent Specification No. 2,225,990 and International Patent Specification Nos. WO93/20911 and WO96/13309. Each of these vehicles is based on a chassis construction, on which a pivotally mounted board or footplate is linked to the steerable front wheels. Tilting the board or footplate turns the wheels in the direction in which it is tilted.

### SUMMARY OF THE INVENTION

According to the present invention, a recreational vehicle has a chassis comprising front and rear sub-frames; a pair of front wheels mounted on either side of the front sub-frame; and a rear wheel assembly mounted on the rear sub-frame. The rear sub-frame is coupled to a steering mechanism operated by rotation of the rear subframe about a longitudinal axis thereof, and relative to the front sub-frame to steer the front wheels. The rear wheel assembly is essentially inflexible such that the rotational axis of the rear wheel is fixed relative to the rear sub-frame.

The front and rear sub-frames may be coupled by a simple longitudinal joint that provides for the requisite relative rotation. In one embodiment of the invention, there is no provision for the wheels to have an independent suspension, and in the effectively unitary chassis formed by the sub-frames, its only flexibility is as a consequence of the inherent flexibility of the material in which the respective sub-frames are made. The material may be steel or a suitable plastics material, high-strength GRP materials being preferred.

Some inherent flexibility may be incorporated in recreational vehicles according to the invention by the selection of the means and material by which the front and rear sub-frames are connected. In another embodiment, respective sub-frames are respectively assembled quite separately, but connected by means of a plate fixedly attached to the rear sub-frame and extending over the front sub-frame. The plate is mounted on the front sub-frame by means of the rotational coupling, and the material of the plate can be selected to provide for some resilient flexibility effectively creating some independent suspension for the rear wheel assembly relative to the front sub-frame. Nevertheless, it is preferred to provide additional suspension systems for the wheels, a trailing arm system being preferred for the rear wheel assembly, and a linkage system for the front wheels of the kind commonly used in motor vehicles.

In the embodiment just described, the plate will typically be a foot plate upon which the rider stands when the vehicle is in use. However, such a plate can also be the basis for other riding positions. Provided the rider can effectively rotate the rear sub-frame relative to the front sub-frame, then the vehicle can be steered.

The rear wheel assembly will normally include only a single wheel. However, multi-wheel units can be incorporated without difficulty. Side-by-side wheels can be used, in which the rear wheel assembly comprises a plurality of rear wheels are typically mounted for rotation about a common axis. Alternatively, a plurality of wheels can be arranged in-line, for rotation about parallel axes, and substantially in the same plane.

The front wheels are typically incorporated in a steering mechanism on the front sub-frame, of the kind commonly used on land vehicles. In one embodiment, the wheels are supported on axle units rotatable in the front sub-frame. The axle units are linked to a steering arm attached to a forward section of the rear assembly such that relative rotation of the sub-frames rotates the axle units to steer the front wheels. The axle units may be mounted in kingpins having axes of rotation fixed relative to the front sub-frame. In an alternative, each axle unit is mounted on a four-bar linkage suspension system of which one bar is fixed relative to the front sub-frame.

### BRIEF DESCRIPTION OF THE DRAWINGS

The invention will now be described by way of example, and with reference to the accompanying drawings wherein:

FIG. 1 is a front perspective view of a recreational vehicle in accordance with the invention;

FIG. 2 is a top perspective view of the vehicle of FIG. 1 with the footplate shown in outline only;

FIG. 3 is a longitudinal cross-sectional view of the vehicles of FIGS. 1 and 2;

FIG. 4 is a front view of the vehicle shown in FIGS. 1 to 3;

FIG. 5 is a front view of an alternative embodiment of the invention;

FIG. 6 shows a top plan view of an alternative rear sub-frame;

FIG. 7 illustrates in a rear view the positions of the wheels and the footplate as the vehicle is being steered to the left.

### DESCRIPTION OF PREFERRED EMBODIMENTS

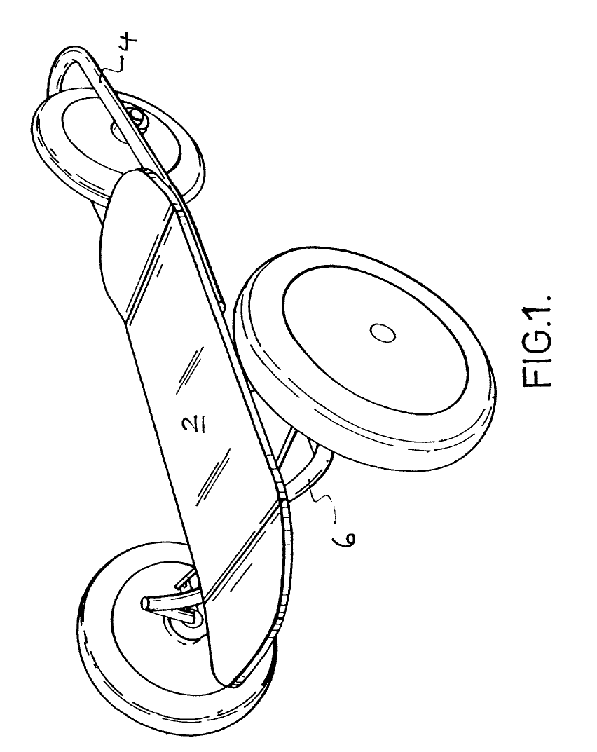

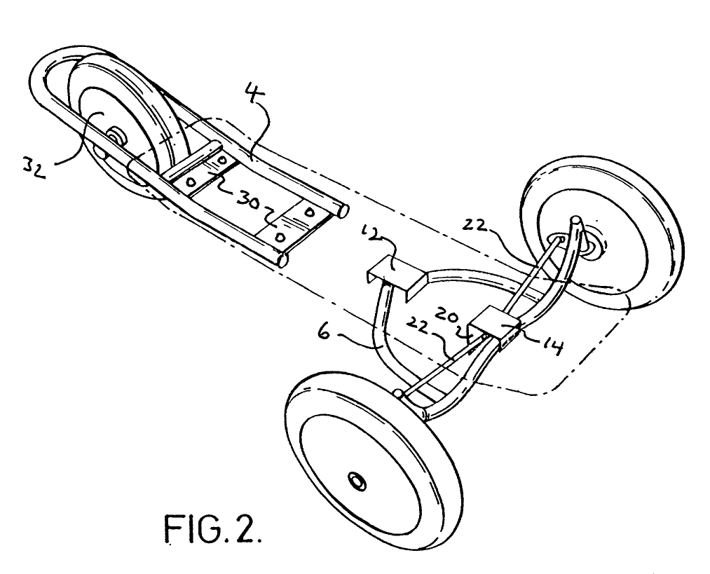

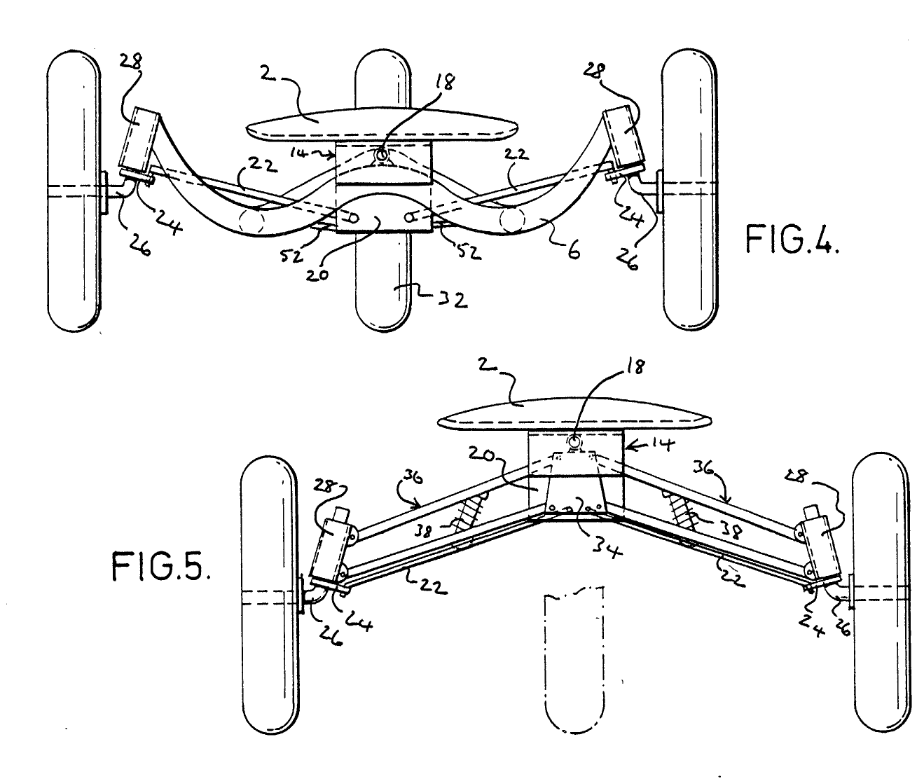

The recreational vehicle shown in FIGS. 1 to 4 has a footplate 2 fixedly mounted on a rear sub-frame 4 and attached to a front sub-frame 6 by means of bearings 8 and 10. Each of these bearings has a respective bracket 12, 14 holding a pin 16, 18 held within a respective union on the sub-frame. The forward bracket 14 has a depending flange 20 to which are coupled two steering rods 22 which extend to lugs 24 attached to stub axles 26 extending from kingpins rotationally mounted in sleeves 28 formed in the front sub-frame 6. Thus, as the footplate tilts and rotates about the bearings 8, 10 the corresponding movement of the lower end of the flange 20 causes the front wheels to turn, as in a conventional motor vehicle front wheels steering mechanism.

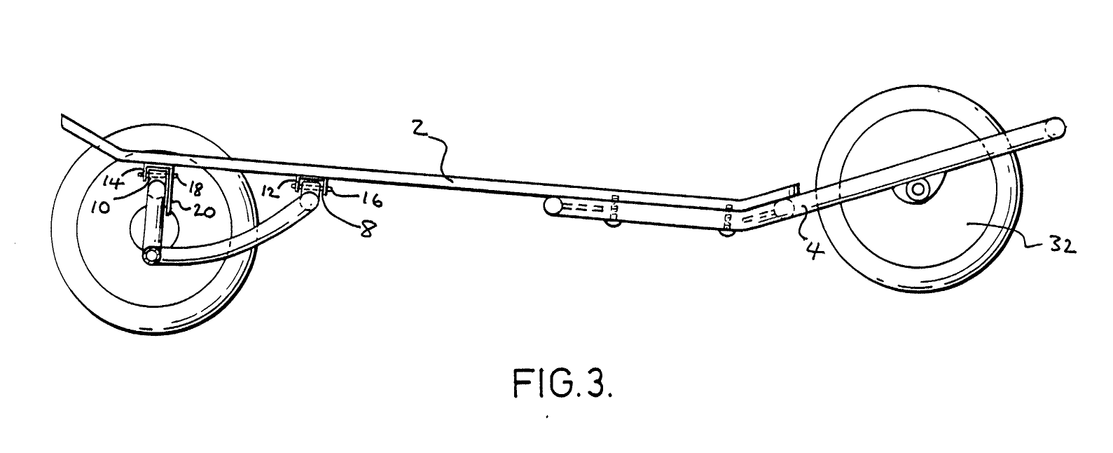

As shown in FIG. 3, the footplate 2 is fixedly attached to the rear sub-frame 4 by means of screws or bolts in the rear sub-frame cross members 30. In turn, the spindle or axle for the single rear wheel 32 is fixed relative to the rear sub-frame 4 with its plane of rotation being substantially perpendicular to the plane of the footplate or at least its main sections.

FIG. 5 shows the front view of an alternative front sub-frame, more particularly a front wheel suspension system that can be incorporated in recreational vehicles of this invention. The system comprises a broadly conventional four bar linkage mechanism for each front wheel extending from a central chassis member 34 which forms one bar of each of the two linkages 36. Springs 38 provide the system with appropriate resilience, but in other respects the vehicle will operate in the same way as the embodiment of FIGS. 1 to 4. It will be noted though, and particularly in the arrangement illustrated, that the position of the plate 2 in this embodiment is rather higher. The drawing represent the vehicle in a standing position, and not in use. Once a rider is installed on the plates 2, it will of course lower as the suspension system comes into effect.

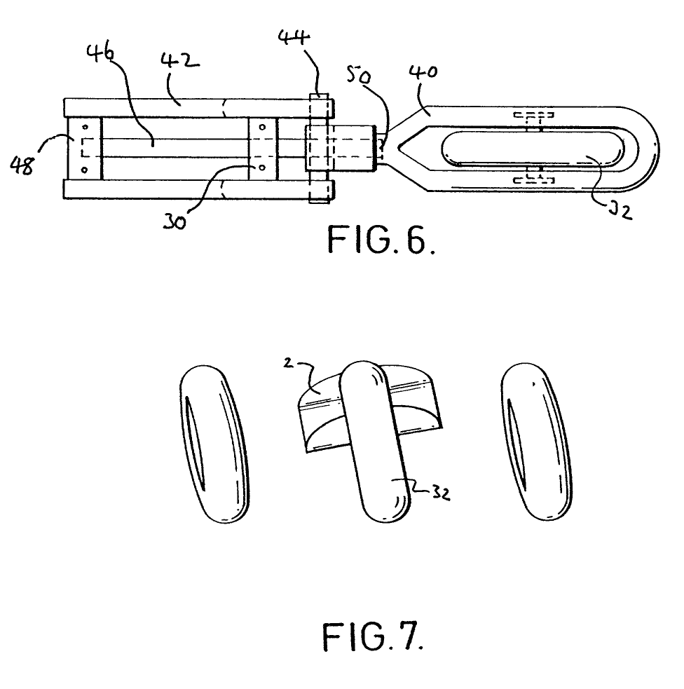

FIG. 6 show an alternative rear sub-frame construction in which the rear wheel has some independent suspension. In this variant, the rear wheel assembly 40 is mounted on rear sub-frame unit 42 for pivotal movement about pin 44. This pivotal movement is controlled by a leaf spring 46 fixed in cross-member 48 at one end, with the other end extending below pin 44, and attached to the rear wheel assembly at 50.

FIG. 7 is a schematic view from the rear showing only the wheels and the footplate, in the orientation they take when the vehicle is being steered to the left.

As the rider leans to the left then so does the rear wheel. The consequential rotation of the rear sub-frame relative to the front sub-frame steers the front wheels to the left as shown, and by virtue of the geometry of the steering system, the front wheels also lean to the left as they are turned. The consequence of this is that the forces generated on the wheels as the vehicle turns are kept substantially in the plane of the wheels, improving adhesion with the substrate upon which the vehicle is moving. This is particularly relevant for the rear wheel assembly which will normally carry the bulk of the rider's weight.

In vehicles according to the invention provision may be made for the coupling between the sub-frames to be resiliently biased towards a neutral position. This will normally be one at which the plane of rotation of the rear wheel is substantially perpendicular to the plane containing the centres of the front wheels and the rear wheel. However, this is not essential as the rider can and does of course balance the vehicle while it is in motion. Nevertheless, a bias can be provided, for example by springs 52 extending between the depending plate 20 and the front sub-frame 6.

1. A recreational vehicle having a chassis comprising front and rear sub-frames; a pair of front wheels mounted on either side of the front sub-frame; and a rear wheel assembly mounted on the rear sub-frame, the rear sub-frame being coupled to a steering mechanism operated by rotation of the rear sub-frame about a longitudinal axis thereof, and relative to the front sub-frame to steer the front wheels, and the rear wheel assembly being inflexible such that the rotational axis of the rear wheel is fixed relative to the rear sub-frame.

2. A vehicle according to claim 1, wherein the front and rear sub-frames are mounted for relative rotation about a common axis defining the longitudinal axis of the rear sub-frame.

3. A vehicle according to claim 1 or claim 2, wherein the coupling between the front and rear sub-frames comprises elements telescopically engaged along the longitudinal axis of the rear sub-frame.

4. A vehicle according to claim 1 or claim 2, wherein the rear sub-frame extends over the front sub-frame, and the coupling therebetween comprises a four-bar linkage in a plane substantially perpendicular to the plane of rotation of the rear wheel, of which two opposite bars are fixed relative to the respective sub-frames.

5. A vehicle according to claim 1 including a footplate fixedly mounted on the rear sub-frame and extending over the front sub-frame.

6. A vehicle according to claim 5 wherein the footplate is mounted on the front sub-frame by means forming the coupling between the front and rear sub-frames.

7. A vehicle according to claim 6 wherein the footplate constitutes the only connection between the front and rear sub-frames.

8. A vehicle according to claim 1, wherein the coupling between the front and rear sub-frames is resiliently biased towards a neutral position at which the plane of rotation of the rear wheel is substantially perpendicular to the plane containing the centres of the front wheels and the rear wheel.

9. A vehicle according to claim 1, wherein the front wheels are supported on axle units rotatable in the front sub-frame, the axle units being linked to a steering arm attached to a forward section of the rear assembly such that said relative rotation of the sub-frames rotates the axle units to steer the front wheels.

10. A vehicle according to claim 9, wherein the axle units are mounted on kingpins having axes of rotation fixed relative to the front sub-frame.

11. A vehicle according to claim 9, wherein each axle unit is mounted on a four-bar linkage suspension system of which one bar is fixed relative to the front sub-frame.

12. A vehicle according to claim 1, wherein the rear wheel assembly is mounted in a suspension system on the rear sub-frame.

13. A vehicle according to claim 12 wherein the suspension system comprises a pivotal link between the rear wheel assembly and the rear sub-frame, the pivotal link having restricted movement against resilient resistance.

14. A vehicle according to claim 1, wherein the rear wheel assembly comprises a single rear wheel.

15. A vehicle according to claim 1, wherein the rear wheel assembly comprises a plurality of rear wheels.

16. A vehicle according to claim 15, wherein the rear wheels are mounted for rotation about a common axis.

17. A vehicle according to claim 15, wherein the rear wheels are mounted for rotation about parallel axes, and in substantially the same plane.
